(19) United States
(12) Patent Application Publication
(10) Pub. No.: US 2023/0374302 A1
(43) Pub. Date: Nov. 23, 2023

(54) THERMOPLASTIC RESIN COMPOSITION, METHOD OF PREPARING THE SAME, AND MOLDED ARTICLE MANUFACTURED USING THE SAME

(71) Applicant: LG CHEM, LTD., Seoul (KR)

(72) Inventors: Gi Dae CHOI, Daejeon (KR); Hyuntae KIM, Daejeon (KR); Myong Jo HAM, Daejeon (KR); Hyeseung HAM, Daejeon (KR); Jinseon KIM, Daejeon (KR)

(21) Appl. No.: 17/630,907

(22) PCT Filed: Jul. 21, 2021
(86) PCT No.: PCT/KR2021/009378

§ 371 Date: Jun. 16, 2022

(30) Foreign Application Priority Data
Dec. 10, 2020 (KR) 10-2020-0172032
Jul. 20, 2021 (KR) 10-2021-0094849

(51) Int. Cl. C08L 71/12; C08J 3/20; C08K 13/06; C09K 21/12

(52) U.S. Cl. CPC C08L 71/123; C08J 3/201; C08K 13/06; C09K 21/12; C08L 2201/02; C08L 2205/03; C08L 2203/30; C08K 5/523

(57) ABSTRACT

A thermoplastic resin composition including 100 parts by weight of a base resin including 50-95% by weight of a polyarylene ether resin (a-1) and 5-50% by weight of a polystyrene resin (a-2); 8.5-16 parts by weight of two or more types of organophosphorus flame retardants (b) having different phosphorus contents; 0.5-3 parts by weight of organoclay (c); 0.5-3.5 parts by weight of pulverized mica (d); 1-4 parts by weight of an alkaline earth metal sulfate (e); and 1-5 parts by weight of a polyfunctional reactant (f), a method of preparing the thermoplastic resin composition, and a molded article including the thermoplastic resin composition. The thermoplastic resin composition has excellent mechanical properties, such as impact strength and tensile strength, heat resistance, electrical insulation, and flame retardancy.

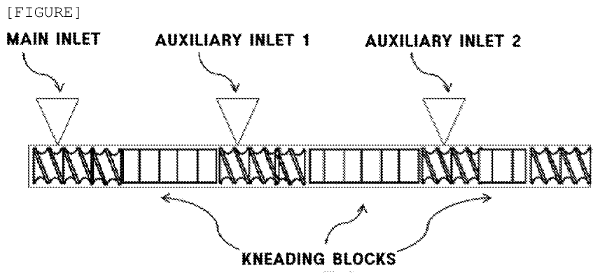

### CROSS-REFERENCE TO RELATED APPLICATIONS

This application is a U.S. national phase of international application No. PCT/KR2021/009378, filed on Jul. 21, 2021, and claims priority to Korean Patent Application No. 10-2020-0172032, filed on Dec. 10, 2020, and Korean Patent Application No. 10-2021-0094849, filed on Jul. 20, 2021, in the Korean Intellectual Property Office, the disclosures of each of which are incorporated herein by reference.

### TECHNICAL FIELD

The present invention relates to a thermoplastic resin composition, a method of preparing the same, and a molded article including the same, and more particularly, to a thermoplastic resin composition having excellent mechanical properties, such as impact strength and tensile strength, heat resistance, electrical insulation, and flame retardancy; a method of preparing the thermoplastic resin composition; and a molded article including the thermoplastic resin composition.

### BACKGROUND

A polyarylene ether resin is a thermoplastic resin having high glass transition temperature, high dimensional stability, lower specific gravity, good hydrolytic stability, and good mechanical performance. However, when polyarylene is used alone, a high processing temperature is required, which deteriorates molding properties. Accordingly, polyarylene ether is mixed with rubber-reinforced polystyrene containing rubber, which is an aromatic vinyl-based polymer, and this mixture is used. In particular, a polyphenylene ether resin containing rubber-reinforced polystyrene has wide-range compatibility regardless of the content of each component. That is, the properties of the polyphenylene ether resin are complementary to those of other components. In addition, polyphenylene ether resins have excellent mechanical properties. With these advantages, polyphenylene ether resins are widely used in various products used in high-temperature environments, for example, automobile parts, electric and electronic parts, and building materials. In addition, glass fiber-reinforced polyarylene ether resins are used in products requiring high flexural modulus and flexural strength.

However, in general, a molded article manufactured using a polyarylene ether resin has excellent physical properties, such as impact strength and tensile strength, appearance, and heat resistance, but has a drawback in that the polyarylene ether resin is combustible. Injection-molded products manufactured by molding the polyarylene ether resin are generally used for final products that generate a lot of heat, such as electrical/electronic products, e.g., computer housings and TV deflectors, and other office equipment. Accordingly, a polyarylene ether resin composition is essentially required to be flame retardant. A method of adding a halogen-based compound and an antimony-based compound to a resin is the most commonly known method used to impart flame retardancy to a resin. As the halogen-based compound, polybromodiphenyl ether, tetrabromobisphenol A, bromine-substituted epoxy compounds, and chlorinated polyethylene are mainly used. As the antimony-based compound, antimony trioxide and antimony pentoxide are mainly used. This method of imparting flame retardancy by simultaneously applying a halogen compound and an antimony compound has advantages such as easy securing of flame retardancy and prevention of deterioration of physical properties. However, hydrogen halide gas generated during processing may be harmful to the human body. Halogen-free flame retardants are called non-halogen flame retardants, and the most widely used non-halogen flame retardants are phosphorus-containing flame retardants. However, the phosphorus-containing flame retardants have flame retardancy significantly inferior to halogen-containing flame retardants. Thus, an excess of a phosphorus-containing flame retardant should be introduced to increase flame retardancy, resulting in deterioration in the physical properties of a resin composition.

In addition, to achieve electrical insulation properties required for automobile parts, electric and electronic parts, etc., a method of adding additives for imparting electrical insulation is used. In this case, mechanical properties such as impact strength may be degraded.

Therefore, a thermoplastic resin composition having excellent mechanical properties, heat resistance, electrical insulation, and flame retardancy needs to be developed.

### RELEVANT PATENT DOCUMENTS

Japanese Application Pub. No. H02-187456

### SUMMARY

Therefore, the present invention has been made in view of the above problems, and it is an objective of the present invention to provide a thermoplastic resin composition having excellent mechanical properties, such as impact strength and tensile strength, heat resistance, electrical insulation, and flame retardancy.

It is another objective of the present invention to provide a method of preparing the thermoplastic resin composition.

It is yet another objective of the present invention to provide a molded article manufactured using the thermoplastic resin composition.

The above and other objectives can be accomplished by the present invention described below.

In accordance with one aspect of the present invention, provided is a thermoplastic resin composition including 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); 0.5 parts to 3.5 parts by weight of pulverized mica (d); 1 part to 4 parts by weight of an alkaline earth metal sulfate (e); and 1 part to 5 parts by weight of a polyfunctional reactant (f).

In accordance with another aspect of the present invention, provided is a thermoplastic resin composition including 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); and 0.5 parts to 3.5 parts by weight of pulverized mica (d), wherein, when electrical insulation properties are measured using an injection specimen (size: 50 mm×50 mm×3 mm) according to ASTM D3638, the thermoplastic resin composition has a tracking resistance of 255 volt or more.

In addition, the present invention may provide a thermoplastic resin composition including 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); 0.5 parts to 3.5 parts by weight of pulverized mica (d); 1 part to 4 parts by weight of an alkaline earth metal sulfate (e); and 1 part to 5 parts by weight of a polyfunctional reactant (f), wherein the two or more types of organophosphorus flame retardants (b) having different phosphorus contents include an organophosphorus flame retardant (b-1) containing 5% to 15% by weight of phosphorus and an organophosphorus flame retardant (b-2) containing 20% to 35% by weight of phosphorus.

In accordance with still another aspect of the present invention, provided is a method of preparing a thermoplastic resin composition, the method including kneading and extruding 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); 0.5 parts to 3.5 parts by weight of pulverized mica (d); 1 part to 4 parts by weight of barium sulfate (e); and 1 part to 5 parts by weight of a polyfunctional reactant (f), wherein the kneading and extrusion are performed using an extruder equipped with 9 or more kneading blocks.

In accordance with still another aspect of the present invention, provided is a method of preparing a thermoplastic resin composition, the method including preparing a thermoplastic resin composition by kneading and extruding 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); and 0.5 parts to 3.5 parts by weight of pulverized mica (d), wherein the kneading and extrusion are performed using an extruder equipped with 9 or more kneading blocks, and when electrical insulation properties are measured using an injection specimen (size: 50 mm×50 mm×3 mm) according to ASTM D3638, the prepared thermoplastic resin composition has a tracking resistance of 255 volt or more.

In addition, the present invention may provide a method of preparing a thermoplastic resin composition, the method including kneading and extruding 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); 0.5 parts to 3.5 parts by weight of pulverized mica (d); 1 part to 4 parts by weight of barium sulfate (e); and 1 part to 5 parts by weight of a polyfunctional reactant (f), wherein the kneading and extrusion are performed using an extruder equipped with 9 or more kneading blocks, and the two or more types of organophosphorus flame retardants (b) having different phosphorus contents include an organophosphorus flame retardant (b-1) containing 5% to 15% by weight of phosphorus and an organophosphorus flame retardant (b-2) containing 20% to 35% by weight of phosphorus.

In accordance with yet another aspect of the present invention, provided is a molded article including the thermoplastic resin composition.

The present invention has an effect of providing a thermoplastic resin composition having excellent mechanical properties, such as impact strength and tensile strength, heat resistance, electrical insulation, and flame retardancy, thus being suitable for use in the manufacture of high-quality electrical/electronic parts, battery parts, and the like that require electrical stability; a method of preparing the thermoplastic resin composition; and a molded article including the thermoplastic resin composition.

### BRIEF DESCRIPTION OF DRAWINGS

The Figure is a schematic illustration of an extruder equipped with 9 or more kneading blocks for preparing the thermoplastic resin composition of the present invention.

### DETAILED DESCRIPTION

Hereinafter, a thermoplastic resin composition, a method of preparing the same, and a molded article including the same according to the present invention will be described in detail.

The present inventors confirmed that, when two or more types of organophosphorus flame retardants having different phosphorus contents, organoclay, pulverized mica, alkaline earth metal sulfate, and a polyfunctional reactant were added in a predetermined ratio to a base resin including a polyarylene ether resin and a polystyrene resin, a thermoplastic resin composition having excellent impact strength, tensile strength, heat resistance, electrical insulation, and flame retardancy was obtained. Based on these results, the present inventors conducted further studies to complete the present invention.

The thermoplastic resin composition of the present invention includes 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); 0.5 parts to 3.5 parts by weight of pulverized mica (d); 1 part to 4 parts by weight of an alkaline earth metal sulfate (e); and 1 part to 5 parts by weight of a polyfunctional reactant (f). In this case, the thermoplastic resin composition may have excellent mechanical properties, such as impact strength and tensile strength, heat resistance, electrical insulation, and flame retardancy.

As another example, the thermoplastic resin composition of the present invention includes 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); and 0.5 parts to 3.5 parts by weight of pulverized mica (d), wherein, when electrical insulation properties are measured using an injection specimen (size: 50 mm×50 mm×3 mm) according to ASTM D3638, the thermoplastic resin composition has a tracking resistance of 255 volt or more. In this case, the thermoplastic resin composition may have excellent mechanical properties, such as impact strength and tensile strength, heat resistance, electrical insulation, and flame retardancy.

Hereinafter, each component of the thermoplastic resin composition of the present invention will be described in detail.

(a-1) Polyarylene ether resin

For example, based on 100 parts by weight of the base resin, the polyarylene ether resin (a-1) may be included in an amount of 50% to 95% by weight, preferably 55% to 90% by weight, more preferably 60% to 85% by weight, still more preferably 65% to 82% by weight, still more preferably 67% to 82% by weight. Within these ranges, mechanical properties and heat resistance may be excellent.

For example, the polyarylene ether resin (a-1) may be a homopolymer or a copolymer including the unit represented by Chemical Formula 1 or 2:

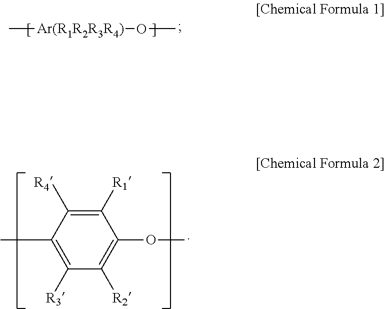

In Chemical Formula 1 and 2, R₁, R₂, R₃, R₄, R₁′, R₂′, R₃′, and R₁′ are substituents of an arylene group (Ar) or a phenylene group, and are each independently or simultaneously hydrogen, chlorine, bromine, iodine, alkyl, allyl, phenyl, alkylbenzyl, chloroalkyl, bromoalkyl, cyanoalkyl, cyano, alkoxy, phenoxy, or a nitro group. Ar is an arylene group having 7 to 20 carbon atoms, and alkoxy may be an alkoxy group having 1 to 4 carbon atoms.

Preferably, R₁, R₂, R₃, R₄, R₁′, R₂′ R₃′, and R₄′ are substituents of an arylene group (Ar) or a phenylene group, and are each independently or simultaneously hydrogen, chlorine, bromine, iodine, methyl, ethyl, propyl, allyl, phenyl, methylbenzyl, chloromethyl, bromomethyl, cyanoethyl, cyano, methoxy, phenoxy, or a nitro group. Ar is an arylene group having 7 to 20 carbon atoms.

For example, the polyarylene ether resin (a-1) may be a polyphenylene ether resin.

As a specific example, a homopolymer of the polyarylene ether resin (a-1) may include one or more selected from the group consisting of poly(2,6-dimethyl-1,4-phenylene) ether, poly(2,6-diethyl-1,4-phenylene) ether, poly(2-methyl-6-propyl-1,4-phenylene) ether, poly(2,6-dipropyl-1,4-phenylene) ether, poly(2-ethyl-6-propyl-1,4-phenylene) ether, poly(2,6-dimethoxy-1,4-phenylene)ether, poly(2,6-dichloromethyl-1,4-phenylene) ether, poly(2,6-dibromomethyl-1,4-phenylene) ether, poly(2,6-diphenyl-1,4-phenylene) ether, and poly(2,5-dimethyl-1,4-phenylene) ether. In this case, mechanical properties, such as impact strength and tensile strength, and processability may be excellent, thereby improving appearance.

In addition, as a specific example, a copolymer of the polyarylene ether resin may include one or more selected from the group consisting of a copolymer of 2,6-dimethylphenol and 2,3,6-trimethylphenol, a copolymer of 2,6-dimethylphenol and o-cresol, and a copolymer of 2,3,6-trimethylphenol and o-cresol. In this case, mechanical properties, such as impact strength and tensile strength, and processability may be excellent, thereby improving appearance.

For example, the polyarylene ether resin (a-1) may have a number average molecular weight of 10,000 g/mol to 100,000 g/mol, preferably 10,000 g/mol to 70,000 g/mol, more preferably 15,000 g/mol to 45,000 g/mol. Within this range, processability and physical property balance may be excellent.

In this description, unless otherwise defined, number average molecular weight may be measured using gel permeation chromatography (GPC, Waters Breeze). As a specific example, number average molecular weight may be measured using chloroform as an eluate through gel permeation chromatography (GPC, Waters Breeze). In this case, number average molecular weight is obtained as a relative value to a polystyrene (PS) standard sample. As a specific measurement example, number average molecular weight may be measured under conditions of solvent: chloroform, column temperature: 40° C., flow rate: 0.3 ml/min, sample concentration: 20 mg/ml, injection amount: 5 μl, column model: 1×PLgel 10 μm MiniMix-B (250×4.6 mm)+1×PLgel 10 μm MiniMix-B (250×4.6 mm)+1×PLgel 10 μm MiniMix-B Guard (50×4.6 mm), equipment name: Agilent 1200 series system, refractive index detector: Agilent G1362 RID, RI temperature: 35° C., data processing: Agilent ChemStation S/W, and test method (Mn, Mw and PDI): OECD TG 118.

For example, the polyarylene ether resin (a-1) may have an intrinsic viscosity of 0.2 dl/g to 0.8 dl/g, preferably 0.3 dl/g to 0.6 dl/g, more preferably 0.35 dl/g to 0.5 dl/g. Within this range, mechanical properties of a composition, such as impact strength and tensile strength, may be maintained at a high level, fluidity suitable for molding may be secured, and compatibility with a polystyrene resin may be excellent.

In this description, unless noted otherwise, when intrinsic viscosity is measured, a sample to be measured is dissolved in chloroform as a solvent to a concentration of 0.5 g/dl, and then the intrinsic viscosity of the sample is measured at 25° C. using an Ubbelohde viscometer.

The polyarylene ether resin (a-1) is preferably in flake or powder form. In this case, mechanical properties, such as impact strength and tensile strength, processability, and appearance may be excellent.

In this description, a flake means a flake-shaped particle including a wide range of scales and granules, and as a specific example, may be a scale having a depth of 1 μm to 20 μm and a length of 0.05 mm to 1 mm. As another example, the flake may have a ratio (L/D) of length to depth of 1.5 to 500, preferably 2 to 100, more preferably 10 to 50.

The flake of the present invention may be prepared by a conventional flake preparation method.

In this description, the depth and length of the flake may be measured by microscopy analysis.

The powder form may be prepared by a powder preparation method commonly known in the art.

(a-2) Polystyrene resin

For example, based on 100 parts by weight of the base resin, the polystyrene resin (a-2) may be included in an amount of 5% to 50% by weight, preferably 10% to 45% by weight, more preferably 15% to 40% by weight, still more preferably 18% to 35% by weight, still more preferably 18% to 33% by weight. Within these ranges, mechanical properties such as impact strength and tensile strength may be excellent.

For example, the polystyrene resin (a-2) may be a general purpose polystyrene resin, a high-impact polystyrene resin, or a mixture thereof, preferably a high-impact polystyrene resin. In this case, processability, dimensional stability, and tensile strength may be excellent.

For example, the general purpose polystyrene resin may be a polymer prepared by polymerizing styrene alone. In this case, processability may be excellent.

For example, the high-impact polystyrene resin may be a rubber-reinforced polystyrene resin.

For example, the rubber may include one or more selected from the group consisting of butadiene-based rubber, isoprene-based rubber, copolymers of butadiene and styrene, and alkyl acrylate rubber, preferably butadiene. In this case, impact strength may be improved.

For example, based on 100% by weight of the high-impact polystyrene resin, the rubber may be included in an amount of 3% to 25% by weight, preferably 6% to 14% by weight, more preferably 8% to 12% by weight. Within these ranges, impact strength and fluidity may be excellent.

For example, the rubber may have a volume average particle diameter of 0.1 μm to 20 μm, preferably 1 μm to 15 μm. Within these ranges, impact strength and fluidity may be excellent.

The rubber-reinforced polystyrene resin preferably includes one or more selected from the group consisting of high-impact styrene-butadiene (HIPS) copolymers, styrene-butadiene-styrene (SBS) copolymers, styrene-ethylene-butylene-styrene (SEBS) copolymers, styrene-butadiene (SB) copolymers, styrene-isoprene (SI) copolymers, styrene-isoprene-styrene (SIS) copolymers, alpha-methylstyrene-butadiene copolymers, styrene-ethylene-propylene copolymers, styrene-ethylene-propylene-styrene copolymers, and styrene-(ethylene-butylene/styrene copolymer)-styrene copolymers.

For example, the rubber-reinforced polystyrene resin may be prepared by polymerizing rubber and an aromatic vinyl compound using bulk polymerization, suspension polymerization, emulsion polymerization, or a mixture thereof. In this case, polymerization may be performed in the presence of a thermal polymerization initiator or a polymerization initiator. For example, the polymerization initiator may be a peroxide-based initiator, an azo-based initiator, or a mixture thereof. The peroxide-based initiator preferably includes one or more selected from the group consisting of benzoylperoxide, t-butyl hydroperoxide, acetyl peroxide, and cumene hydroperoxide, and the azo-based initiator is preferably azobis isobutyronitrile.

In this description, when volume average particle diameter is measured, 3 g of a high-impact polystyrene resin is dissolved in 100 ml of methyl ethyl ketone using a Coulter Counter LS230, and then the volume average particle diameter of non-dissolved and dispersed rubber particles in particulate form is measured using a laser scattering method.

For example, the polystyrene resin may have a melt flow index of 2 g/10 min to 20 g/10 min, preferably 3 g/10 min to 15 g/10 min as measured at 200° C. under 5 kg according to ASTM D1238. Within this range, processability and physical property balance may be excellent.

(b) Two or more types of organophosphorus flame retardants having different phosphorus contents

For example, based on 100 parts by weight of the base resin, the two or more types of organophosphorus flame retardants (b) having different phosphorus contents may be included in an amount of 8.5 parts to 16 parts by weight, preferably 9 parts to 15 parts by weight, more preferably 10 parts to 15 parts by weight, still more preferably 10 parts to 14 parts by weight. In this case, flame retardancy and mechanical properties may be excellent.

For example, the two or more types of organophosphorus flame retardants (b) having different phosphorus contents may include an organophosphorus flame retardant (b-1) containing 5% to 15% by weight of phosphorus and an organophosphorus flame retardant (b-2) containing 20% to 35% by weight of phosphorus, preferably an organophosphorus flame retardant (b-1) containing 7% to 12% by weight of phosphorus and an organophosphorus flame retardant (b-2) containing 22% to 30% by weight of phosphorus. In this case, flame retardancy may be further improved while reducing the content of a flame retardant. In addition, when a specimen is exposed at 60° C. for 7 days, and then flame retardancy is measured, flame retardancy may be excellent. In addition, impact resistance may be excellent.

In this description, phosphorus content means the content (% by weight) of phosphorus converted from the molecular weight of phosphorus contained in the molecular structure of an organophosphorus flame retardant.

For example, the weight ratio of the organophosphorus flame retardant (b-1) to the organophosphorus flame retardant (b-2) (b-1:b-2) may be 1.5:1 to 4.5:1, preferably 1.5:1 to 4:1, more preferably 2:1 to 4:1, still more preferably 2.5:1 to 4:1. Within these ranges, when a specimen is exposed at 60° C. for 7 days, and then flame retardancy is measured, flame retardancy may be excellent. In addition, mechanical strength may be excellent.

For example, the two or more types of organophosphorus flame retardants (b) having different phosphorus contents may include one or more selected from the group consisting of phosphate ester compounds, phosphate-based flame retardants, pyrophosphate-based flame retardants, phosphonate-based flame retardants, metal-substituted phosphinate-based flame retardants, phosphanate-based flame retardants, and metal phosphates.

For example, the phosphate ester compound may be a phosphate compound having an alkyl group or an aromatic group, and preferably includes one or more selected from the group consisting of triphenyl phosphate, tricresyl phosphate, trixylenyl phosphate, cresyl diphenyl phosphate, octyl diphenyl phosphate, bisphenol A diphosphate, and an aromatic diphosphate represented by Chemical Formula 3, more preferably bisphenol A bis(diphenyl phosphate). In this case, flame retardancy may be excellent, and mechanical properties and appearance properties may be improved.

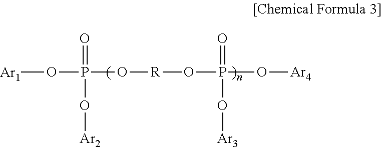

In Chemical Formula 3, Ar₁, Ar₂, Ar₃, and Ar₄ may be the same or different from each other, and may be independently selected from a phenyl group or an aryl group in which 1 to 3 alkyl groups having 1 to 4 carbon atoms are substituted. R may be phenyl or bisphenol-A, and n is an integer of 1 to 5. For example, the aryl group may be an aryl group having 6 to 25 carbon atoms, preferably 6 to 20 carbon atoms, more preferably 6 to 15 carbon atoms, still more preferably 6 to 12 carbon atoms.

For example, the metal-substituted phosphinate may include one or more selected from the group consisting of calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate, zinc methyl-n-propylphosphinate, calcium methanedi(methylphosphinate), magnesium methane di(methylphosphinate), aluminum methanedi(methylphosphinate), zinc methane di(methylphosphinate), calcium benzene-1,4-(dimethylphosphinate), magnesium benzene-1,4-dimethylphosphinate), aluminum benzene-1,4-(dimethylphosphinate), zinc benzene-1,4-(dimethylphosphinate), calcium methylphenylphosphinate, magnesium methylphenylphosphinate, aluminum methylphenylphosphinate, zinc methylphenylphosphinate, calcium diphenylphosphinate, magnesium diphenylphosphinate, aluminum diphenylphosphinate, and zinc diphenylphosphinate.

Preferably, the metal-substituted phosphinate includes one or more selected from the group consisting of aluminum dimethylphosphinate, aluminum ethylmethylphosphinate, and aluminum diethylphosphinate, more preferably aluminum diethylphosphinate. In this case, when a specimen is exposed at 60° C. for 7 days, and flame retardancy is measured, flame retardancy may be excellent.

The metal-substituted phosphinate preferably has a particle diameter of 1 μm to 50 μm, more preferably 1 μm to 20 μm or 30 μm to 50 μm. In this case, the flame retardant and the resin may be uniformly mixed, thereby further improving flame retardancy.

In this description, particle diameter may be measured by a measurement method commonly used in the art to which the present invention pertains, such as electron microscopy analysis.

For example, the metal phosphate may be aluminum phosphate, zinc phosphate, or a mixture thereof. Preferably, the metal phosphate is aluminum dialkylphosphate, zinc dialkylphosphate, or a mixture thereof.

The organophosphorus flame retardant (b-1) containing 5% to 15% by weight of phosphorus is preferably bisphenol A diphenylphosphate, and the organophosphorus flame retardant (b-2) containing 20% to 35% by weight of phosphorus is preferably aluminum diethyl phosphinate.

(c) Organoclay

For example, based on 100 parts by weight of the base resin, the organoclay (c) may be included in an amount of 0.5 parts to 3 parts by weight, preferably 1 part to 2.5 parts by weight, more preferably 1 part to 2 parts by weight. Within these ranges, heat resistance may be excellent while maintaining mechanical properties, processability, and the like at high levels.

In this description, organoclay refers to nanoclay prepared by interaction between unfunctionalized clay and one or more intercalants.

For example, the organoclay (c) may be organic nanoclay.

The nanoclay has a layered structure in which plate-shaped silicate is laminated on a nanometer scale. For example, each layer may have a thickness of 1 nm to 50 nm, preferably 2 nm to 40 nm.

The thickness of the nanoclay may be measured using a method, such as electron microscope analysis, commonly used in the art to which the present invention pertains, and as a specific example, may be measured using dynamic light scattering.

For example, the nanoclay may include one or more selected from the group consisting of smectite-based clay, kaolinite-based clay, and illite-based clay. Preferably, the nanoclay includes one or more selected from the group consisting of montmorillonite, saponite, hectorite, vermiculite, kaolinite, and hydromica, more preferably montmorillonite. In this case, heat resistance may be further improved.

For example, based on a total weight of the organoclay (c), the organoclay (c) may include 1% to 45% by weight, preferably 5% to 40% by weight, more preferably 10% to 35% by weight of an organic modifier. In this case, compatibility with a resin composition may be improved, thereby further increasing heat resistance.

For example, the organic modifier may include one or more selected from the group consisting of tetra alkyl ammonium salts, tetraalkyl phosphonium salts, and ammonium salts containing alkyl and aryl. Preferably, the organic modifier includes one or more selected from the group consisting of dimethyl benzyl hydrogenated tallow quaternary ammonium, dimethyl hydrogenated tallow quaternary ammonium, methyl tallow bis-2-hydroxyethyl quaternary ammonium, and dimethyl hydrogenated tallow 2-ethylhexyl quaternary ammonium. In this case, heat resistance may be further improved.

As a preferred example, the organoclay includes montmorillonite including methyl tallow bis-2-hydroxyethyl quaternary ammonium. In this case, heat resistance may be excellent while maintaining mechanical properties, electrical insulation, and processability at high levels.

(d) Pulverized mica

For example, based on 100 parts by weight of the base resin, the pulverized mica (d) may be included in an amount of 0.5 parts to 3.5 parts by weight, preferably 0.7 parts to 3 parts by weight, more preferably 1 part to 2.5 parts by weight, still more preferably 1 part to 2 parts by weight. Within these ranges, impact resistance, heat resistance, and insulation properties may be excellent.

In this description, the pulverized mica may be defined as pulverized mica having an average particle diameter of 500 μm or less obtained by pulverizing mica at least once.

For example, the pulverized mica (d) may have an average particle diameter of 50 μm to 150 μm, preferably 70 μm to 130 μm. Within these ranges, compatibility with a resin may be excellent, thereby improving impact resistance, heat resistance, flame retardancy, and insulation properties. In addition, a molded article having excellent appearance may be manufactured.

For example, the pulverized mica (d) may have an average aspect ratio of 40 to 60, preferably 45 to 55. Within these ranges, a molded article having excellent appearance may be manufactured.

The aspect ratio refers to a ratio between the length of a long axis and the length of a short axis in a two-dimensional model.

In this description, the average particle diameter and average aspect ratio of pulverized mica may be measured by microscopy analysis. At this time, 30 pieces of pulverized mica are measured, and the average value thereof is calculated.

(e) Alkaline earth metal sulfate

For example, based on 100 parts by weight of the base resin, the alkaline earth metal sulfate (e) may be included in an amount of 1 part to 4 parts by weight, preferably 1 part to 3.5 parts by weight, more preferably 1 part to 3 parts by weight. Within these ranges, insulation properties may be improved, and impact resistance may be excellent.

For example, the alkaline earth metal sulfate (e) may have an average particle diameter of 0.05 parts to 3 μm, preferably 0.1 part to 2.5 μm, more preferably 0.5 parts to 2 μm. Within these ranges, due to excellent compatibility, mechanical properties, insulation properties, and flame retardancy may be improved

In this description, average particle diameter may be measured using a method, such as electron microscopy analysis, commonly used in the art to which the present invention pertains. Specifically, the diameters of 30 particles may be measured, and then the average value thereof may be calculated.

For example, the alkaline earth metal of the alkaline earth metal sulfate (e) may include one or more selected from elements included in group II of the periodic table. Preferably, the alkaline earth metal of the alkaline earth metal sulfate (e) includes one or more selected from the group consisting of calcium, barium, strontium, and magnesium, more preferably calcium, barium, or a mixture thereof, still more preferably barium. In this case, mechanical properties and insulation properties may be improved.

As a preferred example, the alkaline earth metal sulfate (e) may be barium sulfate. In this case, mechanical properties and insulation properties may be improved.

(f) Polyfunctional reactant

For example, based on 100 parts by weight of the base resin, the polyfunctional reactant (f) may be included in an amount of 1 part to 5 parts by weight, preferably 1.5 parts to 4.5 parts by weight, more preferably 1.8 parts to 4 parts by weight, still more preferably 2 parts to 3.5 parts by weight. Within these ranges, mechanical properties, such as tensile strength and impact strength, insulation properties, heat resistance, and flame retardancy may be excellent.

In this description, the polyfunctional reactant refers to a reactant including one or more functional groups selected from the group consisting of a carboxyl group, an amine group, a hydroxyl group, a maleic acid group, and an epoxy group.

For example, the polyfunctional reactant (f) may be an epoxy-based resin, and preferably includes one or more selected from the group consisting of bisphenol A-type epoxy resins, hydrogenated bisphenol A-type epoxy resins, brominated bisphenol A-type epoxy resins, bisphenol F-type epoxy resins, bisphenol S-type epoxy resins, novolac-type epoxy resins, phenol novolac-type epoxy resins, cresol novolac-type epoxy resins, N-glycidyl-type epoxy resins, bisphenol A novolac-type epoxy resins, bixylenol-type epoxy resins, biphenol-type epoxy resins, chelate-type epoxy resins, glyoxal-type epoxy resins, amino group-containing epoxy resins, rubber-modified epoxy resins, dicyclopentadiene phenolic epoxy resins, diglycidyl phthalate resins, heterocyclic epoxy resins, tetraglycidyl xylenoyl ethane resins, silicon-modified epoxy resins, and ε-caprolactone-modified epoxy resins. More preferably, the polyfunctional reactant (f) include one or more selected from the group consisting of novolac-type epoxy resins, phenol novolac-type epoxy resins, and cresol novolac-type epoxy resins, still more preferably cresol novolac-type epoxy resins. In this case, mechanical properties, such as tensile strength and impact strength, insulation properties, heat resistance, and flame retardancy may be excellent.

For example, the epoxy resin may have an average epoxy equivalent of 150 g/eq to 250 g/eq, preferably 170 g/eq to 230 g/eq, more preferably 190 g/eq to 220 g/eq. In this case, a resin composition may be uniformly dispersed, and compatibility may be improved, thereby improving electrical insulation and mechanical properties.

In this description, the average epoxy equivalent means an average molecular weight per one epoxy group.

In this description, when epoxy equivalent (g/eq) is measured, at room temperature, an appropriate amount of a sample is placed in an idle Erlenmeyer flask, and 20 ml of 1,4-dioxane is added thereto to dissolve the sample. When the sample is completely dissolved, 5 ml of HCl is added dropwise. After 30 minutes, a Cresol Red indicator is added, and titration is performed using a NaOH solution. During titration, a point at which the color of the analyte changes from pink to yellow and then to purple is taken as an endpoint. At the same time, a blank test is performed. Then, epoxy equivalent is calculated from Equation 1:

EEW(g/eq)=[Sample weight/(B-A)]×1000. [Equation 1]

In Equation 1, A=Amount of titrant solution consumed during sample titration; and

B=Amount of titrant solution consumed during blank experiment.

For example, the epoxy-based resin may have an ICI viscosity of 1,000 cps to 3,000 cps, preferably 1,800 cps to 2,800 cps. Within these ranges, physical properties such as processability and flame retardancy may be excellent.

In this description, ICI viscosity may be measured at 170° C. using an ICI viscometer.

For example, the epoxy-based resin may have a softening point of 70° C. to 90° C., preferably 75° C. to 85° C. Within these ranges, heat resistance may be further improved.

In this description, a softening point may be measured at a temperature increasing rate of 2° C. using a FP90/FP83HT device (Mettler Toledo Co.).

Thermoplastic Resin Composition

When electrical insulation properties are measured using an injection specimen (size: 50 mm×50 mm×3 mm) according to ASTM D3638, the thermoplastic resin composition of the present invention preferably has a tracking resistance of 255 volt or more, more preferably 290 volt or more, still more preferably 320 volt or more, still more preferably 320 volt to 400 volt, still more preferably 330 volt to 380 volt, still more preferably 340 volt to 370 volt. Within these ranges, physical property balance, flame retardancy, mechanical properties, and electrical insulation may be excellent.

In this description, tracking resistance may be measured using an injection specimen having a size of 50 mm ×50 mm×3 mm according to ASTM D3638. Specifically, tracking resistance is measured using tracking resistance equipment (M31, PTI GmbH Co.) according to ASTM D3638. At this time, a 0.1% (1 g/l L water) ammonium chloride solution is dropped every 30 seconds. A short-cut voltage is measured after 50 drops.

The thermoplastic resin composition preferably has a flame retardancy of at least V-0 grade as measured using an injection specimen having a size of 127 mm×12.7 mm×1.5 mm according to a UL 94 standard (vertical burning test). In this case, physical property balance, heat resistance, mechanical properties, and insulation properties may be excellent.

When an injection specimen having a size of 127 mm×12.7 mm×1.5 mm is placed in a 60° C. oven for 7 days, and then flame retardancy is evaluated according to a UL 94 standard (vertical burning test), the thermoplastic resin composition preferably has a flame retardant stability of at least V-0 grade. In this case, physical property balance may be excellent, and flame retardancy may be maintained at high temperatures.

The thermoplastic resin composition preferably has a tensile strength of 50 MPa or more, more preferably 50 MPa to 60 MPa, still more preferably 51 MPa to 58 MPa, still more preferably 53 MPa to 57 MPa as measured according to ASTM D638. Within these ranges, physical property balance, flame retardancy, heat resistance, and insulation properties may be excellent.

In this description, tensile strength may be measured at cross head speed of 5 mm/min using U.T.M (product name: 4466, manufacturer: Instron) according to ISO 527.

The thermoplastic resin composition preferably has a Notched Izod impact strength of 160 J/m or more, more preferably 165 J/m or more, still more preferably 170 J/m to 220 J/m, still more preferably 175 J/m to 210 J/m, still more preferably 180 J/m to 210 J/m as measured at 23° C. using a specimen having a thickness of 4 mm according to ISO 180A. Within these ranges, physical property balance, heat resistance, flame retardancy, and insulation properties may be excellent.

In this description, Notched Izod impact strength is measured using a notched specimen and using IT (Toyoseiki Co.) under constant temperature and humidity standard conditions according to ISO 180A.

The thermoplastic resin composition preferably has a heat deflection temperature of 128° C. or higher, more preferably 135° C. or higher, still more preferably 140° C. or higher, still more preferably 140° C. to 150° C. as measured using a specimen having a thickness of 4 mm under a stress of 45 MPa according to ISO 75-2. Within these ranges, physical property balance, flame retardancy, mechanical properties, and insulation properties may be excellent.

When necessary, based on 100 parts by weight of the base resin, the thermoplastic resin composition may further include 0.001 part to 5 parts by weight, preferably 0.01 part to 3 parts by weight, more preferably 0.05 parts to 2 parts by weight of each of one or more additives selected from the group consisting of an impact modifier, a flame retardant supplement, a lubricant, a plasticizer, a heat stabilizer, an anti-dripping agent, an antioxidant, a compatibilizer, a light stabilizer, a pigment, a dye, an inorganic additive (except glass fiber), glass fiber, and carbon fiber. Within these ranges, required physical properties may be efficiently expressed without degrading the intrinsic properties of the thermoplastic resin composition of the present invention.

Method of Preparing Thermoplastic Resin Composition

A method of preparing the thermoplastic resin composition of the present invention preferably includes a step of kneading and extruding 100 parts by weight of a base resin including 50% to 95% by weight of a polyarylene ether resin (a-1) and 5% to 50% by weight of a polystyrene resin (a-2), 8.5 parts to 16 parts by weight of two or more types of organophosphorus flame retardants (b) having different phosphorus contents, 0.5 parts to 3 parts by weight of organoclay (c), 0.5 parts to 3.5 parts by weight of pulverized mica (d), 1 part to 4 parts by weight of barium sulfate (e), and 1 part to 5 parts by weight of a polyfunctional reactant (f), wherein the kneading and extrusion are performed using an extruder equipped with 9 or more kneading blocks. In this case, mechanical properties, such as impact strength and tensile strength, heat resistance, electrical insulation, and flame retardancy may be excellent.

As another example, the method of preparing the thermoplastic resin composition of the present invention includes a step of preparing a thermoplastic resin composition by kneading and extruding 100 parts by weight of a base resin including 50% to 95% by weight of a polyarylene ether resin (a-1) and 5% to 50% by weight of a polystyrene resin (a-2); 8.5 parts to 16 parts by weight of two or more types of organophosphorus flame retardants (b) having different phosphorus contents; 0.5 parts to 3 parts by weight of organoclay (c); and 0.5 parts to 3.5 parts by weight of pulverized mica (d), wherein the kneading and extrusion are performed using an extruder equipped with 9 or more kneading blocks, and when electrical insulation properties are measured using an injection specimen (size: 50 mm×50 mm×3 mm) according to ASTM D3638, the prepared thermoplastic resin composition has a tracking resistance of 255 volt or more. In this case, mechanical properties, such as impact strength and tensile strength, heat resistance, electrical insulation, and flame retardancy may be excellent.

For example, the kneading and extrusion may be performed at a barrel temperature of 230° C. to 330° C., preferably 240° C. to 320° C., more preferably 250° C. to 310° C. In this case, throughput per unit time may be increased, melt-kneading may be sufficiently performed, and thermal decomposition of resin components may be prevented.

For example, the kneading and extrusion may be performed at a screw rotation rate of 100 rpm to 500 rpm, preferably 150 rpm to 400 rpm, more preferably 200 rpm to 350 rpm. Within these ranges, throughput per unit time may be increased, and process efficiency may be increased.

The thermoplastic resin composition obtained by kneading and extrusion is preferably provided in the form of pellets.

Molded Article

A molded article of the present invention includes the thermoplastic resin composition of the present invention. In this case, mechanical properties, such as impact strength and tensile strength, heat resistance, electrical insulation, and flame retardancy may be excellent.

For example, the molded article may be formed by injection molding or extrusion molding.

For example, the molded article may be used as an electrical/electronic product or a battery component.

A method of manufacturing a molded article of the present invention preferably includes a step of preparing thermoplastic resin composition pellets by kneading and extruding 100 parts by weight of a base resin including 50% to 95% by weight of a polyarylene ether resin (a-1) and 5% to 50% by weight of a polystyrene resin (a-2), 8.5 parts to 16 parts by weight of two or more types of organophosphorus flame retardants (b) having different phosphorus contents, 0.5 parts to 3 parts by weight of organoclay (c), 0.5 parts to 3.5 parts by weight of pulverized mica (d), 1 part to 4 parts by weight of barium sulfate (e), and 1 part to 5 parts by weight of a polyfunctional reactant (f) and a step of manufacturing a molded article by injecting the prepared pellets, wherein the kneading and extrusion are performed using an extruder equipped with 9 or more kneading blocks. In this case, a molded article having excellent appearance, mechanical properties, flame retardancy, heat resistance, and insulation properties may be provided. Due to these advantageous features, when the molded article is exposed to external environments, changes in the insulation properties of the molded article may be minimized.

In this description, without particular limitation, injection may be performed according to methods and conditions commonly used in the art to which the present invention pertains.

In describing the thermoplastic resin composition, the molded article, the method of preparing the thermoplastic resin composition, and the method of manufacturing the molded article, unless specified otherwise, other conditions (for example, the configuration and specifications of an extruder and an injection machine, extrusion and injection conditions, additives, and the like) may be appropriately selected and implemented as needed when the conditions are within ranges commonly practiced in the art, without particular limitation.

Hereinafter, the present invention will be described with reference to the Figure.

The Figure is a schematic illustration of an extruder equipped with 9 or more kneading blocks for preparing the thermoplastic resin composition of the present invention.

The type of extruder is not particularly limited, and an extruder commonly used in the art may be appropriately selected and used. For example, a single-screw extruder equipped with one screw or a multi-screw extruder equipped with a plurality of screws may be used. Considering uniform kneading of materials, ease of processing, and economic efficiency, a twin-screw extruder equipped with two screws is preferably used.

The extruder includes a raw material feeder for feeding materials into a barrel, a screw for conveying and kneading the fed materials, and a die for extruding the kneaded materials. In this case, the screw consists of a plurality of screw elements for various functions.

In the extruder, one or more raw material feeders may be provided, and two or more raw material feeders may be provided, as needed. In addition, a main inlet may be provided, and two or more auxiliary inlets may be optionally provided.

As a specific example, the base resin, the two or more types of organophosphorus flame retardants having different phosphorus contents, the organoclay, the pulverized mica, the alkaline earth metal sulfate, and the polyfunctional reactant may be fed into the main inlet batch-wise. As another example, all components except for the two or more types of organophosphorus flame retardants having different phosphorus contents may be fed into the main inlet, and the two or more types of organophosphorus flame retardants having different phosphorus contents may be fed into the auxiliary inlets.

As another example, all components except for the two or more types of organophosphorus flame retardants having different phosphorus contents may be fed into the main inlet, the two or more types of organophosphorus flame retardants having different phosphorus contents may be fed into the auxiliary inlet 1, and additives, such as an impact modifier, a flame retardant supplement, glass fiber, carbon fiber, a lubricant, a plasticizer, and a light stabilizer, may be fed into the auxiliary inlet 2.

As another example, the base resin and the polyfunctional reactant may be fed into the main inlet, a portion of the two or more types of organophosphorus flame retardants having different phosphorus contents, the organoclay, the pulverized mica, and the alkaline earth metal sulfate may be fed into the auxiliary inlet 1, and the remainder may be fed into the auxiliary inlet 2.

As another example, the base resin may be fed into the main inlet, the two or more types of organophosphorus flame retardants having different phosphorus contents, the organoclay, the pulverized mica, and the alkaline earth metal sulfate may be fed into the auxiliary inlet 1, and the polyfunctional reactant may be fed into the auxiliary inlet 2.

The kneading blocks of the present invention correspond to the screw elements. Specifically, each kneading block consists of a plurality of discs, preferably 3 to 7 discs, 5 to 7 discs, 3 to 5 discs, or 4 to 5 discs, and has a polygonal cross section or an elliptical cross section. The kneading blocks are arranged continuously in a direction in which materials are conveyed. In addition, in the kneading block, the phase angle of the discs (indicating the travel angle between discs) is preferably 45 to 90°.

In addition, the kneading block includes a forward kneading block capable of conveying, distributing, and mixing materials, a neutral kneading block capable of distributing and mixing materials without conveying the same, and a backward kneading block capable of conveying materials in a direction opposite to the conveying direction.

For example, the thermoplastic resin composition according to the present invention may be prepared using a method including a step of performing kneading and extrusion using an extruder equipped with 9 or more, preferably 10 or more, more preferably 12 or more kneading blocks, as a preferred example, 9 to 18 kneading blocks, as a more preferred example, 10 to 18 kneading blocks, as a still more preferred example, 12 to 16 kneading blocks. In this case, it may be effective to arrange the kneading blocks in the order of forward kneading blocks, neutral kneading blocks, and backward kneading blocks with respect to a resin flow direction. Depending on the manner of combination, a continuous or separate block combination may be used. In this case, the dispersibility of organoclay and pulverized mica and the compatibility of a composition may be further improved, thereby providing a high-quality thermoplastic resin composition.

9 or more kneading blocks may be arranged continuously, or may be arranged discontinuously between screws. As a specific example: 3 to 6 kneading blocks may be provided continuously between the main inlet and the auxiliary inlet 1; 3 to 8 kneading blocks may be provided continuously between the auxiliary inlet 1 and the auxiliary inlet 2; and 2 to 5 kneading blocks may be provided between the auxiliary inlet 2 and an outlet (not shown). With this configuration, local heat generation during melt-kneading may be controlled to prevent thermal deformation of raw materials. In addition, excessive cutting of nanoscale components may be prevented, thereby preventing deterioration in electrical insulation and physical properties.

Hereinafter, the present invention will be described in more detail with reference to the following preferred examples. However, these examples are provided for illustrative purposes only and should not be construed as limiting the scope and spirit of the present invention. In addition, it will be apparent to those skilled in the art that various changes and modifications may be made without departing from the spirit and scope of the present invention, and such changes and modifications are also within the scope of the appended claims.

### EXAMPLES

Components used in Examples and Comparative Examples below are as follows:

(a-1) Polyarylene ether resin: Poly(2,6-dimethyl-1,4-phenylene) ether (LXR040, Bluestar Co.);

(a-2) Polystrene resin: RIPS resin (SP510, LG Chemical Co.);

(b) Two or more types of organophosphorus flame retardants having different phosphorus contents: (b-1) bisphenol A diphenylphosphate (BPADA, FCA Co.) containing 9% by weight of phosphorus and (b-2) aluminum diethyl phosphinate (OP1230, Clariant Co.) containing 25% by weight of phosphorus;

(c) Organoclay: Nanosilicate (30B, SCP Co.) (organized with methyl tallow bis-2-hydroxyethyl quaternary ammonium);

(d) Pulverized mica: Pulverized mica (200D, Kurary Co.) having an average particle diameter of 90 μm and an aspect ratio of 50;

(e) Alkaline earth metal sulfate: Barium sulfate (HD80, Solvay Co.) having an average particle diameter of 1 μm; and

(f) Polyfunctional reactant: Novolac-type epoxy resin (YDCN-500-8P, epoxy equivalent: 200 g/eq to 212 g/eq, softening point: 68° C. to 75° C., Kukdo Chemical Co.).

### Examples 1 to 8 and Comparative Examples 1 to 11

According to the contents shown in Tables 1 and 2, a polyarylene ether resin (a-1), a polystyrene resin (a-2), an organophosphorus flame retardant (b-1) containing 9% by weight of phosphorus, an organophosphorus flame retardant (b-2) containing 25% by weight of phosphorus, organoclay (c), pulverized mica (d), alkaline earth metal sulfate (e), and a polyfunctional reactant (f) were fed into a twin-screw extruder equipped with 10 mixing blocks (T40, SM Co.). Then, melt-kneading and extrusion were performed at a temperature of 250° C. to 310° C. and a rotation rate of 300 rpm to prepare pellets. The obtained pellets were injected using an injection machine (80 tons, Engel Co.) to prepare a specimen for evaluation. The obtained specimen was allowed to stand at room temperature (20° C. to 26° C.) for 48 hours, and the physical properties thereof were measured. The obtained results are shown in Tables 1 and 2.

The twin-screw extruder had a total of two or more inlets. Components except for the organophosphorus flame retardant were fed into the main inlet, and the organophosphorus flame retardant was fed into the auxiliary inlets.

### Test Example

The properties of specimens prepared in Examples 1 to 8 and Comparative Examples 1 to 11 were measured according to the following methods, and the results are shown in Tables 1 and 2.

Measurement Methods

Tensile strength (MPa): When a specimen was pulled at a cross head speed of 5 mm/min using U.T.M (product name: 4466, manufacturer: Instron) according to ISO 527 and the specimen was cut, a cut point in the specimen was measured.

Izod impact strength (J/m): Impact strength was measured using an IT device (Toyoseiki Co.) under constant temperature and humidity standard conditions according to ISO 180A. At this time, a notched specimen having a thickness of 4 mm was used.

Heat deflection temperature (° C.): Heat deflection temperature was measured using a specimen having a thickness of 4 mm under a stress of 45 MPa according to ISO 75-2.

Tracking resistance (volt): According to ASTM D3638, the tracking resistance of an injection specimen was measured as electrical insulation properties. Specifically, an injection specimen having a size of 50 mm×50 mm×3 mm was prepared. Then, tracking resistance was measured using tracking resistance equipment (M31, PTI GmbH Co.) according to ASTM D3638. At this time, a 0.1% ammonium chloride solution was dropped every 30 seconds. After 50 drops, a short-cut voltage was measured.

Flame retardancy: Flame retardancy was measured using an injection specimen having a size of 127 mm×12.7 mm ×1.5 mm according to UL 94 standard (vertical burning test).

Flame retardant stability: An injection specimen having a size of 127 mm×12.7 mm×1.5 mm was placed in a 60° C. oven for 7 days, and then flame retardancy was measured according to a UL 94 standard (vertical burning test). Based on flame retardancy, flame retardant stability was evaluated. As flame retardancy grade increases, flame retardant stability increases.

TABLE 1

| | Examples | | | | | | | |
|---|---|---|---|---|---|---|---|---|
| Classification | 1 | 2 | 3 | 4 | 5 | 6 | 7 | 8 |
| (a-1) PPE | 60 | 70 | 80 | 80 | 70 | 70 | 80 | 90 |
| (a-2) HIPS | 40 | 30 | 20 | 20 | 30 | 30 | 20 | 10 |
| (b-1) Flame | 10 | 10 | 8 | 8 | 9 | 12 | 9 | 8 |
| retardant | | | | | | | | |
| containing low | | | | | | | | |
| phosphorus | | | | | | | | |
| content | | | | | | | | |
| (b-2) Flame | 5 | 4 | 2 | 2 | 6 | 3 | 6 | 2 |
| retardant | | | | | | | | |
| containing | | | | | | | | |
| high | | | | | | | | |
| phosphorus | | | | | | | | |
| content | | | | | | | | |
| (c) Organoclay | 2 | 2 | 1 | 1 | 2 | 2 | 1 | 1 |
| (d) Pulverized | 2 | 3 | 2 | 1 | 3 | 3 | 2 | 2 |
| mica | | | | | | | | |
| (e) Small | 2 | 3 | 1 | 2 | 3 | 3 | 1 | 2 |
| particle | | | | | | | | |
| diameter | | | | | | | | |
| barium sulfate | | | | | | | | |
| (f) | 2 | 3 | 2 | 3 | 3 | 3 | 2 | 2 |
| Polyfunctional | | | | | | | | |
| reactant | | | | | | | | |

Physical properties

| | | | | | | | | |
|---|---|---|---|---|---|---|---|---|
| Tensile | 50 | 52 | 55 | 52 | 54 | 50 | 56 | 57 |
| strength (MPa) | | | | | | | | |
| Impact | 180 | 200 | 170 | 180 | 190 | 210 | 170 | 190 |
| strength (J/m) | | | | | | | | |
| Heat | 130 | 141 | 145 | 147 | 144 | 135 | 141 | 148 |
| deflection | | | | | | | | |
| temperature | | | | | | | | |
| (° C.) | | | | | | | | |
| Tracking | 350 | 375 | 325 | 350 | 375 | 350 | 325 | 300 |
| resistance | | | | | | | | |
| (volt) | | | | | | | | |
| Flame | V0 | V0 | V0 | V0 | V0 | V0 | V0 | V0 |
| retardancy | | | | | | | | |
| (UL94) | | | | | | | | |
| Flame | V0 | V0 | V0 | V0 | V0 | V0 | V0 | V0 |
| retardant | | | | | | | | |
| stability | | | | | | | | |
| (UL94) | | | | | | | | |

TABLE 2

| | Comparative Examples | | | | | | | | | | |
|---|---|---|---|---|---|---|---|---|---|---|---|
| Classification | 1 | 2 | 3 | 4 | 5 | 6 | 7 | 8 | 9 | 10 | 11 |
| (a-1) PPE | 60 | 60 | 70 | 70 | 80 | 80 | 80 | 70 | 70 | 70 | 70 |
| (a-2) HIPS | 40 | 40 | 30 | 30 | 20 | 20 | 20 | 30 | 30 | 30 | 30 |
| (b-1) Flame | 17 | — | 10 | 10 | 8 | 8 | 8 | 10 | 10 | 10 | 10 |
| retardant | | | | | | | | | | | |
| containing low | | | | | | | | | | | |
| phosphorus | | | | | | | | | | | |
| content | | | | | | | | | | | |
| (b-2) Flame | — | 7 | 4 | 4 | 2 | 2 | 2 | 4 | 4 | 4 | 4 |
| retardant | | | | | | | | | | | |
| containing | | | | | | | | | | | |
| high | | | | | | | | | | | |
| phosphorus | | | | | | | | | | | |
| content | | | | | | | | | | | |
| (c) Organoclay | 2 | 2 | — | 2 | 1 | 1 | 1 | 4 | 2 | 2 | 2 |
| (d) Pulverized | 2 | 2 | 3 | — | 1 | 1 | 1 | 3 | 4 | 3 | 3 |
| mica | | | | | | | | | | | |
| (e) Small | 2 | 2 | 3 | 3 | — | 2 | 2 | 3 | 3 | 5 | 3 |
| particle | | | | | | | | | | | |
| diameter | | | | | | | | | | | |
| barium sulfate | | | | | | | | | | | |
| (f) | 2 | 2 | 3 | 3 | 3 | — | 6 | 3 | 3 | 3 | 6 |
| Polyfunctional | | | | | | | | | | | |
| reactant | | | | | | | | | | | |

Physical properties

| | | | | | | | | | | | |
|---|---|---|---|---|---|---|---|---|---|---|---|
| Tensile | 47 | 51 | 52 | 51 | 47 | 43 | 49 | 52 | 51 | 52 | 49 |
| strength (MPa) | | | | | | | | | | | |
| Impact | 95 | 100 | 120 | 130 | 135 | 87 | 110 | 100 | 90 | 95 | 130 |
| strength (J/m) | | | | | | | | | | | |
| Heat | 93 | 120 | 125 | 120 | 130 | 125 | 130 | 125 | 124 | 123 | 118 |
| deflection | | | | | | | | | | | |
| temperature | | | | | | | | | | | |
| (° C.) | | | | | | | | | | | |
| Tracking | 200 | 225 | 225 | 225 | 175 | 200 | 225 | 200 | 225 | 250 | 225 |
| resistance | | | | | | | | | | | |
| (volt) | | | | | | | | | | | |
| Flame | V2 | V1 | V2 | V1 | V1 | V2 | V1 | V1 | V1 | V1 | V1 |
| retardancy | | | | | | | | | | | |
| (UL94) | | | | | | | | | | | |
| Flame | HB | V2 | V2 | V2 | V2 | HB | HB | V2 | V1 | V2 | V2 |
| retardant | | | | | | | | | | | |
| stability | | | | | | | | | | | |
| (UL94) | | | | | | | | | | | |

As shown in Tables 1 and 2, compared to Comparative Examples 1 and 11, the thermoplastic resin compositions according to the present invention (Examples 1 to 8) have excellent mechanical properties, such as tensile strength and impact strength, heat deflection temperature, flame retardancy, flame retardant stability, and tracking resistance. Specifically, in the case of Comparative Examples 1 and 2, each of which includes one type of phosphorus flame retardant, tensile strength, impact strength, heat deflection temperature, tracking resistance, flame retardancy, and flame retardant stability are all poor.

In addition, in the case of Comparative Example 3, which does not include the organoclay (c), and Comparative Example 4, which does not include the pulverized mica (d), impact strength, heat deflection temperature, and flame retardancy are reduced. In particular, tracking resistance is significantly reduced.

In addition, in the case of Comparative Example 5, which does not include the barium sulfate (e), mechanical properties such as tensile strength and impact strength are degraded. In addition, flame retardancy and tracking resistance are very poor.

In addition, in the case of Comparative Examples 6 and 7, in which the polyfunctional reactant (f) is not included or the polyfunctional reactant (f) is included in an amount exceeding the range of the present invention, mechanical properties, heat resistance, and tracking resistance are deteriorated. In particular, flame retardancy and flame retardant stability are significantly degraded.

In addition, in the case of Comparative Example 8, in which the organoclay (c) is included in an amount exceeding the range of the present invention, impact strength is significantly reduced. In the case of Comparative Examples 9 and 10, in which each of the pulverized mica (d) and the barium sulfate (e), respectively, is included in an amount exceeding the range of the present invention, impact strength and heat deflection temperature are reduced. In the case of Comparative Example 11, in which the polyfunctional reactant (f) is included in an amount exceeding the range of the present invention, heat deflection temperature is decreased.

1. A thermoplastic resin composition, comprising:
100 parts by weight of a base resin comprising 50% to 95-% by weight of a polyarylene ether resin (a-1) and 5% to 50-% by weight of a polystyrene resin (a-2);
8.5 parts to 16 parts by weight of two or more types of organophosphorus flame retardants (b) having different phosphorus contents;
0.5 parts to 3 parts by weight of organoclay (c);
0.5 parts to 3.5 parts by weight of pulverized mica (d);
1 part to 4 parts by weight of an alkaline earth metal sulfate (e); and
1 part to 5 parts by weight of a polyfunctional reactant (f).

2. The thermoplastic resin composition according to claim 1, wherein the polyarylene ether resin (a-1) has an intrinsic viscosity of 0.2 dl/g to 0.8 dl/g.

3. The thermoplastic resin composition according to claim 1, wherein the polystyrene resin (a-2) is a general purpose polystyrene, a high-impact polystyrene, or a mixture thereof.

4. The thermoplastic resin composition according to claim 1, wherein the two or more types of organophosphorus flame retardants (b) having different phosphorus contents comprise an organophosphorus flame retardant (b-1) containing 5% to 15-% by weight of phosphorus and an organophosphorus flame retardant (b-2) containing 20% to 35-% by weight of phosphorus.

5. The thermoplastic resin composition according to claim 4, wherein a weight ratio of the organophosphorus flame retardant (b-1) to the organophosphorus flame retardant (b-2) is 1.5:1 to 4.5:1.

6. The thermoplastic resin composition according to claim 1, wherein the two or more types of organophosphorus flame retardants (b) having different phosphorus contents comprise one or more selected from the group consisting of phosphate ester compounds, phosphate-based flame retardants, pyrophosphate-based flame retardants, phosphonate-based flame retardants, metal-substituted phosphinate-based flame retardants, phosphanate-based flame retardants, and metal phosphates.

7. The thermoplastic resin composition according to claim 1, further comprising 1% to 45-% by weight of an organic modifier based on a total weight of the organoclay (c).

8. The thermoplastic resin composition according to claim 1, wherein the pulverized mica (d) has an average particle diameter of 50 μm to 150 μm.

9. The thermoplastic resin composition according to claim 1, wherein the alkaline earth metal sulfate (e) has an average particle diameter of 0.05 μm to 3 μm.

10. The thermoplastic resin composition according to claim 1, wherein the polyfunctional reactant (f) comprises one or more selected from the group consisting of bisphenol A-type epoxy resins, hydrogenated bisphenol A-type epoxy resins, brominated bisphenol A-type epoxy resins, bisphenol F-type epoxy resins, bisphenol S-type epoxy resins, novolac-type epoxy resins, phenol novolac-type epoxy resins, cresol novolac-type epoxy resins, N-glycidyl-type epoxy resins, bisphenol A novolac-type epoxy resins, bixylenol-type epoxy resins, biphenol-type epoxy resins, chelate-type epoxy resins, glyoxal-type epoxy resins, amino group-containing epoxy resins, rubber-modified epoxy resins, dicyclopentadiene phenolic epoxy resins, diglycidyl phthalate resins, heterocyclic epoxy resins, tetraglycidyl xylenoyl ethane resins, silicone-modified epoxy resins, and ε-caprolactone-modified epoxy resins.

11. A thermoplastic resin composition, comprising:
100 parts by weight of a base resin comprising 50% to 95-% by weight of a polyarylene ether resin (a-1) and 5% to 50-% by weight of a polystyrene resin (a-2);
8.5 parts to 16 parts by weight of two or more types of organophosphorus flame retardants (b) having different phosphorus contents;
0.5 parts to 3 parts by weight of organoclay (c); and
0.5 parts to 3.5 parts by weight of pulverized mica (d),
wherein, when electrical insulation properties are measured using an injection specimen (size: 50 mm×50 mm×3 mm) according to ASTM D3638, the thermoplastic resin composition has a tracking resistance of 255 volt or more.

12. The thermoplastic resin composition according to claim 1, wherein the thermoplastic resin composition has a flame retardancy of at least V-0 grade as measured according to a UL 94 standard (vertical burning test) after exposing an injection specimen at 60-° C. for 7 days.

13. The thermoplastic resin composition according to claim 1, wherein the thermoplastic resin composition comprises one or more selected from the group consisting of an impact modifier, a flame retardant supplement, a lubricant, a plasticizer, a heat stabilizer, an anti-dripping agent, an antioxidant, a compatibilizer, a light stabilizer, a pigment, a dye, an inorganic additive (except glass fiber), glass fiber, and carbon fiber.

14. A method of preparing a thermoplastic resin composition, comprising kneading and extruding 100 parts by weight of a base resin comprising 50% to 95-% by weight of a polyarylene ether resin (a-1) and 5% to 50-% by weight of a polystyrene resin (a-2); 8.5 parts to 16 parts by weight of two or more types of organophosphorus flame retardants (b) having different phosphorus contents; 0.5 parts to 3 parts by weight of organoclay (c); 0.5 parts to 3.5 parts by weight of pulverized mica (d); 1 part to 4 parts by weight of an alkaline earth metal sulfate (e); and 1 part to 5 parts by weight of a polyfunctional reactant (f),
wherein the kneading and extrusion are performed using an extruder equipped with nine or more kneading blocks.

15. A method of preparing a thermoplastic resin composition, comprising preparing a thermoplastic resin composition by kneading and extruding 100 parts by weight of a base resin comprising 50% to 95-% by weight of a polyarylene ether resin (a-1) and 5% to 50-% by weight of a polystyrene resin (a-2); 8.5 parts to 16 parts by weight of two or more types of organophosphorus flame retardants (b) having different phosphorus contents; 0.5 parts to 3 parts by weight of organoclay (c); and 0.5 parts to 3.5 parts by weight of pulverized mica (d),
wherein the kneading and extrusion are performed using an extruder equipped with 9 nine or more kneading blocks, and
when electrical insulation properties are measured using an injection specimen (size:
50 mm×50 mm×3 mm) according to ASTM D3638, the prepared thermoplastic resin composition has a tracking resistance of 255 volt or more.

16. A molded article, comprising the thermoplastic resin composition according to claim 1.

17. A molded article, comprising the thermoplastic resin composition according to claim 11.

18. The thermoplastic resin composition according to claim 11, wherein the thermoplastic resin composition has a flame retardancy of at least V-0 grade as measured according to a UL 94 standard (vertical burning test) after exposing an injection specimen at 60° C. for 7 days.

19. The thermoplastic resin composition according to claim 11, wherein the thermoplastic resin composition comprises one or more selected from the group consisting of an impact modifier, a flame retardant supplement, a lubricant, a plasticizer, a heat stabilizer, an anti-dripping agent, an antioxidant, a compatibilizer, a light stabilizer, a pigment, a dye, an inorganic additive (except glass fiber), glass fiber, and carbon fiber.
